(19) United States
(12) Patent Application Publication
(10) Pub. No.: US 2011/0110757 A1
(43) Pub. Date: May 12, 2011

(54) Mobile Technology Delivery and Configuration Center

(76) Inventor: Dean M. Pehlke, Edgar, WI (US)

(21) Appl. No.: 12/941,485

(22) Filed: Nov. 8, 2010

Related U.S. Application Data
(60) Provisional application No. 61/258,948, filed on Nov. 6, 2009.

(51) Int. Cl. B65G 49/00; B62D 21/20; B62B 3/00

(52) U.S. Cl. 414/809; 280/79.2; 280/47.34

(57) ABSTRACT

The invention outlined in the disclosure is a mobile delivery and technology center for provisioning and delivering electronic devices from a originating location to a target location or receiving campus. The center allows the transport of devices in the original equipment manufacturing (OEM) packaging, with an area designed for un-packaging and provisioning computers at the target location before installation.

### RELATED APPLICATIONS

This application claims priority from U.S. provisional application No. 61/258,948 filed 6 Nov. 2009; the entire contents being hereby incorporated by reference and for which benefit of the priority date is claimed.

### FIELD OF THE INVENTION

The present invention relates to a method and apparatus for the efficient implementation of electronic device, and more particularly, to delivering and configuring multiple computers at a remote site.

### BACKGROUND OF THE INVENTION

In the past, electronic device such as computers and the like have many times been provisioned at the place of use, such as office space etc. This process interrupts work flow and creates down time for valuable employees. The process has been disruptive, cumbersome, tedious, expensive, and unfriendly to the receiving campus work environment.

Others have looked to address such interruption of work flow by receiving the electronic equipment from an original equipment manufacturer (OEM), taking it to a warehouse or other such facility to serve as a staging area, doing the provisioning steps at the facility, then providing specialized racks or shipping compartments for shipping the equipment in an unboxed state from the staging facility to the user campus. Such solutions require handling the equipment at least twice, first at the separate facility for staging and handling, then at the user facility. Further, should there be a problem or change with the shipment, former methods do not allow facilities on site for fixing the problems or making the changes. In addition to increased handling, there is the additional operational costs of having to provide the separate facility for doing the configurations.

### SUMMARY OF THE INVENTION

The invention outlined in the disclosure comprises multiple new features and advantaged not found prior in the industry. Having a mobile technology delivery and configuration center allows a provider to receive a shipment of electronic devices from and OEM and deliver it in boxed form to a client or end customer's location where provisioning and personalization steps are performed.

Below are listed several advantages from such an approach. This by no means forms a comprehensive list of advantages.

It is an advantage of the present invention to provide a staging area for computers apart from, but adjacent to, the receiving campus.

It is a further advantage to save space within the receiving campus.

It is a further advantage to reduce clutter and refuse, such as packing materials, from the receiving campus, thus promoting professionalism of appearance.

It is a further advantage to minimize disruption of work flow at the receiving campus.

It is a further advantage to bring in the devices in large quantities on the multi tiered cart from the compartment or trailer to the desk in one step.

It is a further advantage to pick up and remove old devices from the receiving campus in the same process of rolling out and installing the new devices, and to use the multi-tiered carts to remove the old devices from the campus with a minimal disruption of work flow.

It is a further advantage to return the old devices to the compartment or trailer for recycling.

It is a further advantage to eliminate the need for the equipment or devices to be opened prior to going on campus thus further utilizing the OEM packaging.

It is a further advantage to limit operational costs by not having to purchase or rent a separate facility to do configurations.

It is a further advantage to provide a site adjacent to the campus with facility to accommodate last minute changes or alterations.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a flow diagram of an example delivery, provisioning and deployment;

FIG. 2 is a schematic floor plan of an example mobile deployment center;

FIG. 3 is a flow diagram of a preferred example delivery, provisioning and deployment supplying detail steps;

FIG. 4 is an example imaging schematic by means of a KVM switch.

### DESCRIPTION OF A PREFERRED EMBODIMENT

FIG. 2 shows a generally preferred embodiment of the present invention being a mobile delivery and technology center. Some components of the invention comprise a vehicle which may be in the form of a truck chassis having an integrated box or compartment, or in another embodiment, a separate trailer compartment (120) or the like having wheels (122) with means to tow (124) or move the trailer from one location to another. In this case the trailer compartment (120) would be towed behind a vehicle. The compartment (120) is generally adapted with fixed or reconfigurable surfaces and shelves, and having room for movable carts. The compartment may have storage bin (110), generally designed as an area for boxed product, to transport to a client's location, and an area to remove the packaging. After the devices are unpackaged, they can be place on a mobile single or multi tiered cart (310), and moved to a mobile configuration station (422) having a seat (424) for an operator or technician and provided with multiple power outlets (426) positioned locations convenient to the technician. The vehicle or compartment (120) may have power generation capabilities or plug directly into an external power source to provide power to the outlets (426). The outlets (426) will provide power to the lights, the computing equipment for imaging, printers and client devices and may also provide heating, air conditioning and any additional needs. A desk top computer or server (428) is provided for the technician to facilitate the process of configuring computers or other electronic devices. Additionally a hub (420) having the capability to interface with multiple computers is provided to further facilitate the provisioning process.

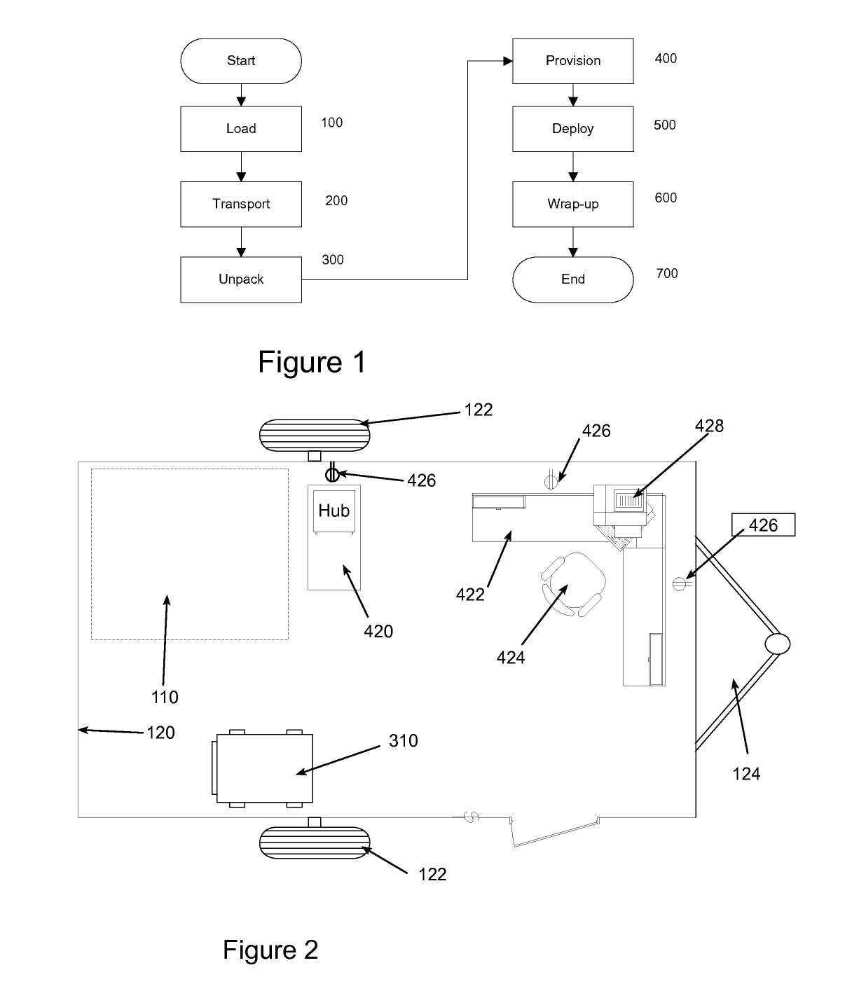

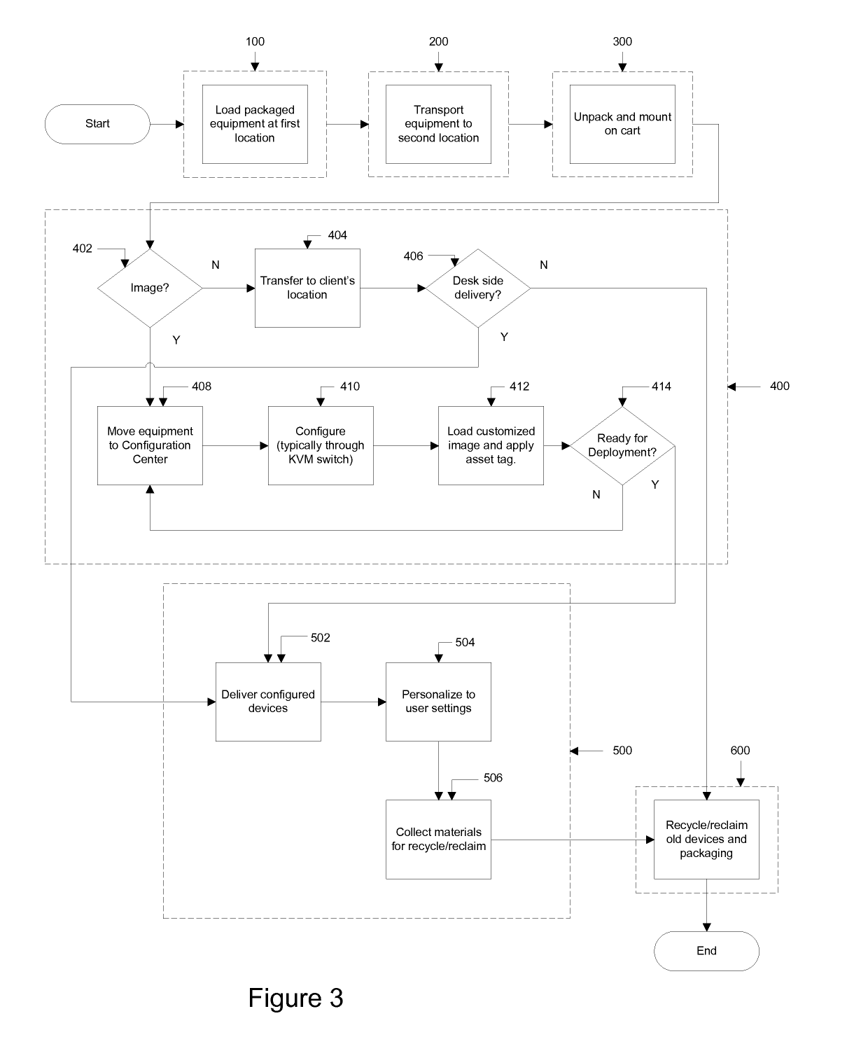

FIG. 1 combined with FIG. 3 shows a top level methodology with detailed steps having loading step (100) whereby boxed product, typically as received from the factory or original equipment manufacturer (OEM), is loaded aboard the compartment (120) for transport. The boxed product, or devices generally comprises; printers, monitors, mice, keyboards, servers, spare parts, computers, laptops, switches, hubs, routers and the like and are secured for transport in the storage bin (110) as boxed product. The storage bin (110) having fastening and securing means for transport as known by those generally skilled in the art.

The transport step (200) comprises moving the compartment (120) from a first location where the loading occurred to a second location generally referred to as a client's location or receiving campus. This process can include multiple stops at multiple locations and multiple clients.

The unpack step (300) includes having an individual or team of individuals preferably a team of technicians, enter the compartment (120) and remove the packaging or boxes from the product or devices. The packaging material can then be stored back into the storage bin (110) for later disposition. This operation can also include the steps of placing the devices on a cart or carts (310) in a predetermined fashion. This operation can also include applying an asset tag or other identifying feature on the devices for future reference.

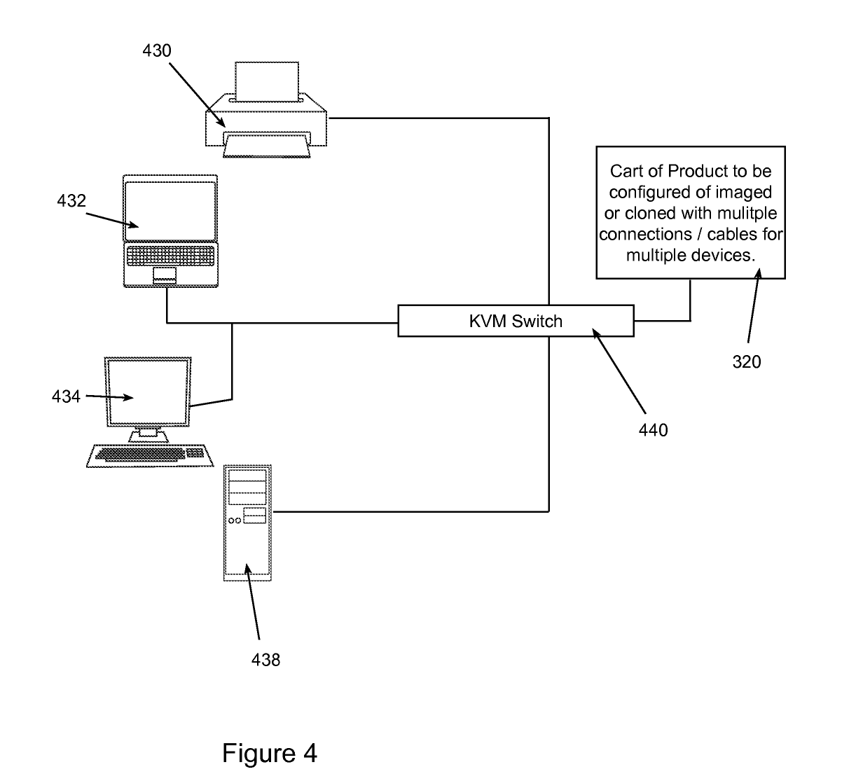

Upon completion of the unpack step the devices are ready for provisioning (400). During the provision (400) step, several choices are made in order to customize devices utilization upon deployment (500). One decision step involves whether or not the devices should be imaged (402). If the answer is “Yes”, the devices are moved to a configuration station (422) for the configuration step (408). Imaging is generally the process of putting or loading files or programs to the equipment to personalize the equipment to the specific client, or to allow disparate or different pieces of equipment to act as a system. This is usually accomplished by providing the desired program, typically configured to the client's specification, (412) to a master device such as a computer (428) or hub (420) and copying or cloning from the master device to the target device. The configuration step is preferably done through a KVM switch (410), or equivalent structure, to facilitate the operation. As shown in FIG. 4, KVM switch apparatus (440), as detailed generally combines a; computer (434), workstation server (438), laptop (432), all having a keyboard, mouse, imaging devices and video, and the like and a printer (430) in communication with the KVM switch (440) in order to easily switch control between computers generally provided on a cart (310) (320). Upon completion of the imaging process (412), the equipment is checked to assess if it is ready for deployment (414). If not ready, or problems are found, the equipment may be moved back through the configuration center (408) where reprogramming or troubleshooting is commenced. An end objective of the provisioning step (400) is to configure as fully as possible the system to the user's configuration. Once this objective is satisfactorily determined, The equipment is ready for deployment (500).

Deployment generally involves delivering the configured devices (502) transporting, typically on a cart (310), and locating the devices to their appropriate location(s) in the receiving facility. Generally, the devices are further personalized to the user's settings (504) or desires, such as; further imaging, font size preferences, default settings, network connections, settings downloaded, files imported for a previous device. Existing (old) devices may be collected or taken for removal. Typically this step takes the form of collect materials for recycle/reclaim (506). In this step, the old devices are typically placed upon the wheeled cart for removal.

While disposal may take place at the client's campus, the carts are typically loaded to the compartment where the devices are sorted for recycling, reclaim, or refuse (600).

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

Having thus described the invention, what is desired to be protected by Letters Patent is presented in the subsequent appended claims.

We claim:

1. A method of, packing, transporting, provisioning, and delivering a plurality of electronic devices, comprising the steps of:
a. providing a transport compartment having equipment sufficient to provision a plurality of electronic devices from a group of; printers, monitors, mice, keyboards, servers, spare parts, laptops, switches hubs, routers;
b. configuring a load of at least one boxed device from the group of; printers, monitors, mice, keyboards, servers, spare parts, laptops, switches hubs, routers and securing the load aboard the transport compartment at a first location;
c. moving the loaded transport compartment to a second location;
d. supplying a team having at least one technician at the second location to enter the transport compartment
e. unboxing and provisioning the devices aboard the transport compartment;
f. placing the provisioned devices on a cart or carts and delivering the device to a receiving campus at the second location.

2. The method of claim 1, wherein the transport compartment comprises a truck chassis having an integrated box or compartment.

3. The method of claim 1, wherein the transport compartment comprises a trailer being towed behind a vehicle.

4. The method of claim 1, wherein the transport compartment comprises and electrical power generation source.

5. The method of claim 4, wherein the electrical power generation source further comprises electrical outlets at predetermined locations.

6. The method of claim 1, wherein the cart is a multi tiered cart having rollers, and wherein said loading step includes rolling the cart from the transport compartment to the receiving campus.

7. The method of claim 6, wherein the steps include the step of applying an asset tag to at least one device for future reference.

8. The method of claim 6, wherein the step of provisioning includes the further step of moving the device to a configuration center where the device is configured and imaged to a client's specification.

9. The method of claim 8, wherein the configuration step further includes providing a master device configured to the client's specification and copying the configuration from the master device to the device being provisioned.

10. The method of claim 9, wherein the step of configuration is done through a KVM switch.

11. The method of claim 9, wherein the steps include the further step of troubleshooting.

12. The method of claim 9, comprising the added steps of deployment and further personalizing the electronic device to a user's desires and collecting existing devices for removal from the appropriate location in the receiving facility.

13. A mobile delivery and technology configuration center for provisioning and delivering electronic devices comprising:
a. a vehicle or trailer having a storage compartment for transporting packaged electronic devices from a first location to a second location, and a workspace for removing packaging from said electronic devices and assembling a finished electronic device;
b. movable carts adapted to receiving the assembled electronic devices;
c. the vehicle or trailer having power generation capabilities for providing power to at least one computer,
d. a server or other computing device adapted to perform imaging or cloning of software and operating configurations sufficient to personalize a computer,

14. The mobile delivery and technology center as provided in claim 4 further comprising a KVM switch.

15. The mobile delivery and technology center as provided in claim 4 further comprising an asset tag printer.

16. The mobile delivery and technology center as provided in claim 4 further comprising at least one desk.

17. The mobile delivery and technology center as provided in claim 4 further comprising a space for refuse generated from OEM packaging provided with a new computer.
